(19) United States
(12) Patent Application Publication
(10) Pub. No.: US 2026/0087276 A1
(43) Pub. Date: Mar. 26, 2026

(54) CARD READER

(71) Applicant: NIDEC INSTRUMENTS CORPORATION, Nagano (JP)

(72) Inventors: Mamoru MIZAWA, Nagano (JP); Ryo UCHIYAMA, Nagano (JP); Keiji OHTA, Nagano (JP)

(21) Appl. No.: 19/333,355

(22) Filed: Sep. 19, 2025

(30) Foreign Application Priority Data
Sep. 20, 2024 (JP) 2024-163833
Nov. 26, 2024 (JP) 2024-205134

(51) Int. Cl. G06K 7/10

(52) U.S. Cl. CPC G06K 7/10009

(57) ABSTRACT

A card reader includes a main body frame formed with a card moving passage where a card inserted from a card insertion slot is moved. The main body frame is formed with a moving passage forming face which is a lower side face of the card moving passage, a receiving part which is recessed from the moving passage forming face toward a lower side and is disposed on the lower side in a vertical direction with respect to the card which is in contact with the moving passage forming face, and a liquid discharge passage for discharging liquid accumulated in the receiving part from the receiving part to an outside of the card reader.

### CROSS REFERENCE TO RELATED APPLICATION

The present invention claims priority under 35 U.S.C. § 119 to Japanese Application No. 2024-163833 filed Sep. 20, 2024 and Japanese Application No. 2024-205134 filed Nov. 26, 2024, the entire contents of which are incorporated herein by reference.

### FIELD OF THE INVENTION

An embodiment of the present invention may relate to a card reader.

### BACKGROUND

Conventionally, a card reader has been known in which a user manually operates a card to perform reading of data recorded in a card (for example, see Japanese Patent Laid-Open No. 2024-72507 (Patent Literature 1)). The card reader described in Patent Literature 1 includes a main body frame formed with a card moving passage where a card is moved, and a foreign matter receiving member which is fixed to a bottom face side of the main body frame. An inside of the main body frame is formed with a card accommodating part where a part of the card inserted into the card reader is accommodated. The foreign matter receiving member is provided with a foreign matter receiving part.

In the card reader described in Patent Literature 1, a discharge hole is formed in a bottom face of the main body frame. The discharge hole leads to the card accommodating part and the foreign matter receiving part. In the card reader described in Patent Literature 1, a foreign matter entered into the card accommodating part is capable of being discharged from the card accommodating part to the foreign matter receiving part through the discharge hole and accommodated in the foreign matter receiving part. Therefore, in the card reader, even when a foreign matter such as a coin is inserted from a card insertion slot, clogging of the foreign matter in the card accommodating part is prevented and transaction of a card can be continued in the card reader.

In the card reader described in Patent Literature 1, according to an environment where the card reader is installed and used, liquid such as water may enter into an inside of the card reader from a card insertion slot and accumulated in the foreign matter receiving part. When the liquid accumulated in the foreign matter receiving part is left as it is, some trouble may occur due to the liquid accumulated in the foreign matter receiving part.

### SUMMARY

In view of the problem described above, at least an embodiment of the present invention may advantageously provide a card reader which is capable of continuing transactions of a card even when a foreign matter is inserted from a card insertion slot and capable of suppressing occurrence of trouble due to liquid accumulated in its inside.

According to at least an embodiment of the present invention, there may be provided a card reader structured to perform at least one of reading of data recorded in a card and recording of data to the card. The card reader includes a main body frame which is formed with a card moving passage where the card inserted from a card insertion slot is moved and, in a case that one side in a moving direction of the card which is linearly moved in the card moving passage is referred to as a front side, an opposite side to the front side is referred to as a rear side, and one side in a thickness direction of the card which is moved in the card moving passage is referred to as a first direction side, the card is inserted into the card insertion slot from the front side toward the rear side, and the main body frame is formed with a moving passage forming face which is a face on the first direction side of the card moving passage, a receiving part which is recessed from the moving passage forming face toward the first direction side and is disposed on a lower side in a vertical direction with respect to the card which is in contact with the moving passage forming face, and a liquid discharge passage for discharging liquid accumulated in the receiving part from the receiving part to the outside of the card reader.

In the card reader in this embodiment, the main body frame is formed with the receiving part which is recessed from the moving passage forming face that is a face on the first direction side of the card moving passage toward the first direction side and is disposed on a lower side in the vertical direction with respect to a card which is in contact with the moving passage forming face. Therefore, according to this embodiment, a foreign matter inserted from the card insertion slot can be dropped to the receiving part and accommodated in the receiving part. Accordingly, in this embodiment, even when a foreign matter is inserted from the card insertion slot, clogging of the card moving passage due to the foreign matter is prevented and subsequent transactions of a card in the card reader can be continued.

Further, in this embodiment, the main body frame is formed with the liquid discharge passage for discharging liquid accumulated in the receiving part from the receiving part to the outside of the card reader. Therefore, the liquid accumulated in the receiving part can be discharged to the outside of the card reader by utilizing the liquid discharge passage. Accordingly, in this embodiment, even when the receiving part is formed in the main body frame, occurrence of trouble of the card reader due to liquid accumulated in an inside of the card reader can be suppressed.

### Effects of the Invention

As descried above, in the card reader in accordance with an embodiment of the invention, even when a foreign matter is inserted from the card insertion slot, subsequent transactions of a card can be continued and occurrence of trouble of the card reader due to liquid accumulated in an inside of the card reader can be suppressed.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a perspective view showing a card reader in accordance with an embodiment of the present invention.

FIG. 2 is a perspective view showing a state that a main case body is detached from the card reader shown in FIG. 1 and is viewed in a different direction.

FIG. 3 is a perspective view showing a state that the main case body, a circuit board, a printed board, an upper frame and the like are detached from the card reader shown in FIG. 1.

FIG. 4 is a perspective view showing a front face cover, a first frame, a receiving part forming member and the like shown in FIG. 3 which are viewed in a different direction.

FIG. 5 is a perspective view showing a portion of a card reader main body shown in FIG. 1.

FIG. 6 is a cross-sectional view showing the front face cover, the first frame, the receiving part forming member and the like shown in FIG. 4.

FIG. 7 is an enlarged view showing the “E”-part in FIG. 6.

FIG. 8 is a cross-sectional view showing the “F-F” cross section in FIG. 7.

FIG. 9 is a perspective view showing the first frame in FIG. 6.

FIG. 10 is a perspective view showing the receiving part forming member in FIG. 6.

FIG. 11 is a plan view showing a sealing member in FIG. 7.

FIG. 12 is a perspective view showing a bezel in FIG. 6.

FIG. 13 is a perspective view showing the bezel in FIG. 12 which is viewed in a different direction.

### DETAILED DESCRIPTION

An embodiment of the present invention will be described below with reference to the accompanying drawings.

### (Entire Structure of Card Reader)

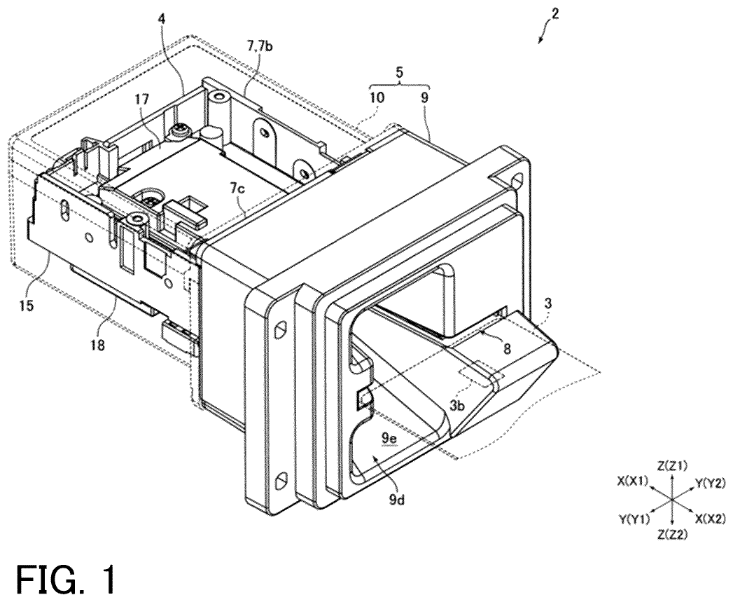

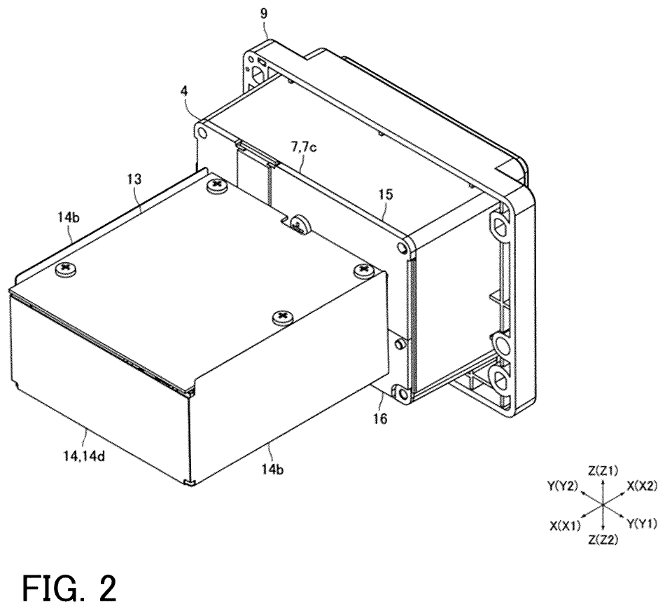

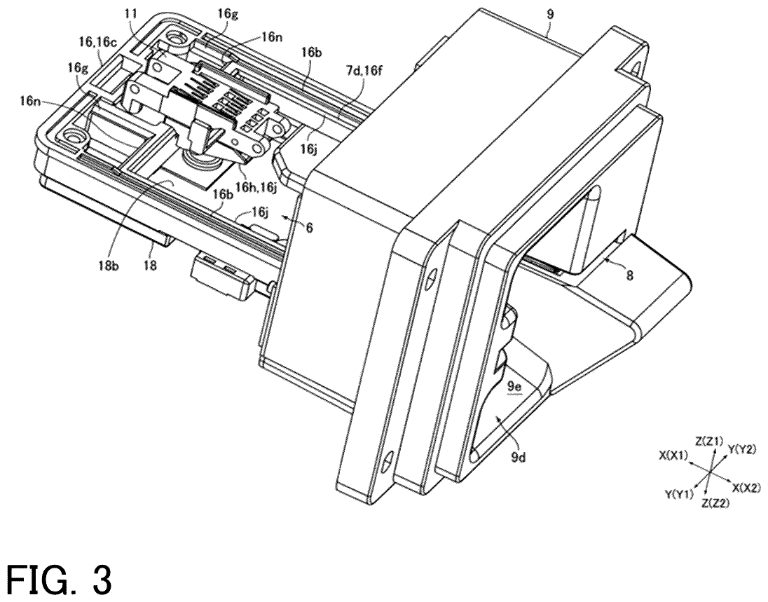

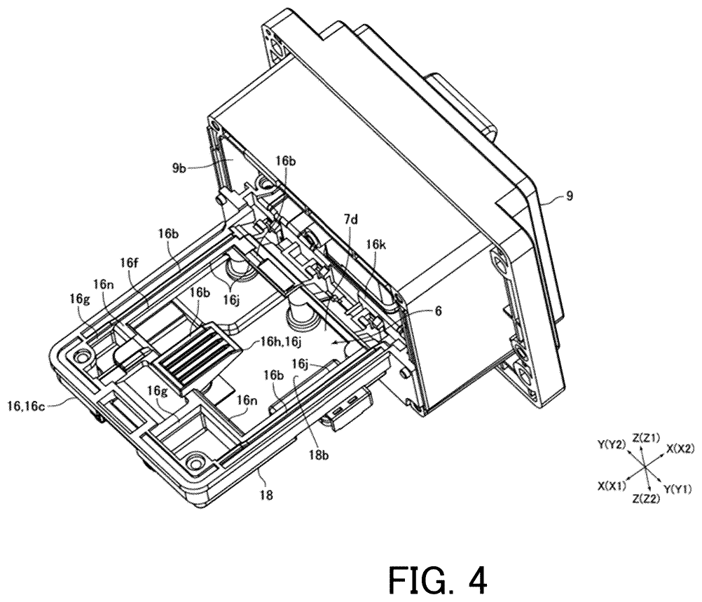

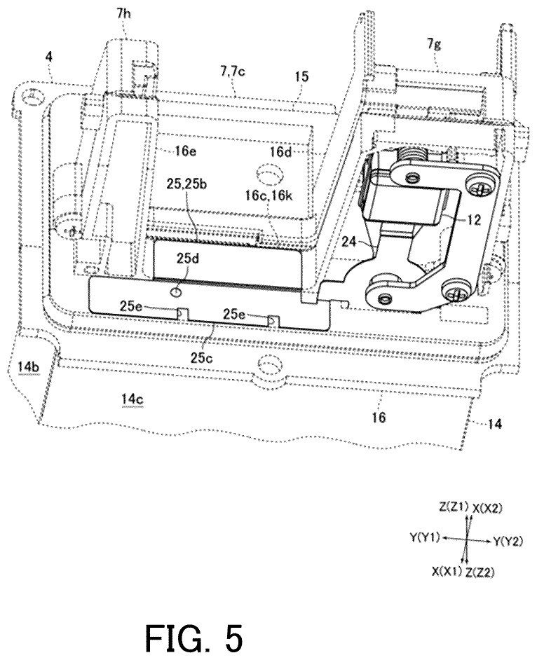

FIG. 1 is a perspective view showing a card reader 2 in accordance with an embodiment of the present invention. FIG. 2 is a perspective view showing a state that a main case body 10 is detached from the card reader 2 shown in FIG. 1 and is viewed in a different direction. FIG. 3 is a perspective view showing a state that the main case body 10, a circuit board 13, a printed board 14, an upper side frame 15 and the like are detached from the card reader 2 shown in FIG. 1. FIG. 4 is a perspective view showing a bezel 9, a lower side frame 16, a lower cover 18 and the like shown in FIG. 3 which are viewed in a different direction. FIG. 5 is a perspective view showing a portion of a card reader main body 4 shown in FIG. 1.

A card reader 2 in this embodiment is a device for performing at least one of reading of data recorded in a card 3 and recording of data to the card 3. Specifically, the card reader 2 is a so-called dip-type card reader in which insertion of a card 3 to the card reader 2 and pulling-out of the card 3 from the card reader 2 are manually performed to read and record data. The card reader 2 is, for example, installed and used in a predetermined host apparatus such as an oil supply apparatus of a gas station in an unmanned or self-service system. Liquid such as water may be used around the host apparatus.

A card 3 is, for example, a card made of vinyl chloride whose thickness is about 0.7-0.8 mm. The card 3 is formed in a rectangular shape. The card 3 has a built-in IC chip, and one face of the card 3 is formed with an external connection terminal 3b of the IC chip (see FIG. 1). Further, the other face of the card 3 is formed with a magnetic stripe in which magnetic data are recorded.

The card reader 2 includes a card reader main body 4 and a case body 5 which covers the card reader main body 4. The card reader main body 4 includes a main body frame 7 which is formed with a card moving passage 6 where a card 3 is moved. The case body 5 is structured of a bezel 9 as a front face cover which is formed with a card insertion slot 8 into which a card 3 is inserted, and the main case body 10. In the card moving passage 6, a card 3 inserted from the card insertion slot 8 is moved.

The card reader main body 4 includes an IC contact block 11 (see FIG. 3) for communicating data with a card 3, a magnetic head 12 (see FIG. 5) for performing at least one of reading of magnetic data recorded in a card 3 and recording of magnetic data to the card 3, a circuit board 13 (see FIG. 2) which is a printed board for control, and a printed board 14 (see FIG. 2) for preventing defrauding of data from the card reader 2. The IC contact block 11 includes a plurality of IC contact springs structured to contact with an external connection terminal 3b of a card 3. The IC contact block 11 in this embodiment is a data reading mechanism for at least reading data recorded in a card 3. In FIG. 1, the circuit board 13 and the printed board 14 are not shown.

In this embodiment, a card 3 which is manually operated is linearly moved in the X-direction in FIG. 1 and the like. In other words, the X-direction is a moving direction of a card 3 which is linearly moved in the card moving passage 6. A card 3 is inserted to the X1-direction side in FIG. 1 and the like, which is one side in the X-direction, and is pulled out to the X2-direction side in FIG. 1 and the like which is the other side in the X-direction. Further, the Z-direction in FIG. 1 and the like which is perpendicular to the X-direction is a thickness direction of a card 3 which is linearly moved in the card moving passage 6, and the Y-direction in FIG. 1 and the like which is perpendicular to the X-direction and the Z-direction is a width direction (short width direction) of a card 3 which is linearly moved in the card moving passage 6.

In the following descriptions, for convenience of explanation, the X-direction is defined as a front-rear direction, the Y-direction is defined as a left-right direction, and the Z-direction is defined as an upper-lower direction. Further, the X2-direction side which is a pulling-out direction of a card 3 from the card reader 2 is referred to as a “front” side, and the X1-direction side which is the opposite side (an inserting direction side of the card 3 to the card reader 2) is referred to as a “rear” side. In other words, the X2-direction side which is one side in the moving direction of a card 3 is referred to as a “front” side, and the opposite side is referred to as a “rear” side. A card 3 is inserted into the card insertion slot 8 from the front side toward the rear side.

Further, in the following descriptions, the Y1-direction side in FIG. 1 and the like which is one side in the left-right direction is defined as a “left” side, the Y2-direction side in FIG. 1 and the like which is the opposite side is defined as a “right” side, the Z1-direction side in FIG. 1 and the like which is one side in the upper-lower direction is defined as an “upper” side, and the Z2-direction side in FIG. 1 and the like which is the opposite side is defined as a “lower” side. The IC contact block 11 is disposed so that the IC contact springs face the card moving passage 6 from the upper side, and the magnetic head 12 is disposed so that a magnetic gap faces the card moving passage 6 from the lower side. The lower side (Z2-direction side) in this embodiment is a first direction side which is one side in a thickness direction of a card 3, and the upper side (Z1-direction side) is a second direction side which is the opposite side to the first direction side.

In this embodiment, the Z-direction (upper-lower direction) of the card reader 2 in a state mounted on a host apparatus does not completely coincide with the vertical direction, and the Z-direction of the card reader 2 in a state mounted on a host apparatus slightly inclines with respect to the vertical direction. Specifically, the Z-direction of the card reader 2 in a state mounted on a host apparatus slightly inclines with respect to the vertical direction so that its front side (X2-direction side) is slightly disposed on the “lower side (side where gravity acts) in the vertical direction” with respect to the rear side (X1-direction side). An inclination of the card reader 2 in a state mounted on a host apparatus with respect to the Z-direction, i.e., the vertical direction is slight and thus, the Z2-direction side (lower side) of the card reader 2 in a state mounted on a host apparatus almost coincides with the “lower side in the vertical direction”, and the Z1-direction side (upper side) of the card reader 2 in the state mounted on the host apparatus almost coincides with the “upper side in the vertical direction”. However, the Z-direction of the card reader 2 in a state mounted on the host apparatus may completely coincide with the vertical direction.

The main body frame 7 is provided with a card accommodating part 7b in a bag shape in which a rear side portion of a card 3 inserted into the card reader 2 (in other words, a card 3 inserted from the card insertion slot 8) is accommodated, and a partition part 7c enlarged in a flange shape from a front end of the card accommodating part 7b. An inside of the card accommodating part 7b is structured to be a part of the card moving passage 6. An opening part leading to the card moving passage 6 from the outside of the card accommodating part 7b is not formed in both upper and lower faces, both right and left faces and a rear face of the card accommodating part 7b. The partition part 7c is formed in a rectangular frame shape which is enlarged in the upper-lower direction and the left-right direction.

The main body frame 7 is, in addition to the card accommodating part 7b and the partition part 7c, provided with a head arrangement part 7g where the magnetic head 12 is disposed, and a card guide part 7h for guiding a card 3 inserted from the card insertion slot 8 (see FIG. 5). The head arrangement part 7g and the card guide part 7h protrude from a front face of the partition part 7c to the front side. The head arrangement part 7g and the card guide part 7h are disposed with a space therebetween in the left-right direction. In this embodiment, the head arrangement part 7g is disposed on the right side, and the card guide part 7h is disposed on the left side. In FIG. 5, for convenience of explanation, the main body frame 7 and the printed board 14 are shown by a broken line.

Further, the main body frame 7 includes an upper side frame 15 and a lower side frame 16 which are divided in the upper-lower direction, an upper cover 17 fixed to the upper side of the upper side frame 15, and a lower cover 18 fixed to the lower side of the lower side frame 16. In this embodiment, the card accommodating part 7b is structured of an about half portion on the rear side of the upper side frame 15, an about half portion on the rear side of the lower side frame 16, the upper cover 17 and the lower cover 18.

The upper side frame 15, the lower side frame 16, the upper cover 17 and the lower cover 18 are formed of resin. The card moving passage 6 is formed between the upper side frame 15 and the lower side frame 16 and is formed in an inside of the main body frame 7. The upper side frame 15 is formed with an upper face of the card moving passage 6. The lower side frame 16 is formed with a lower face of the card moving passage 6. The lower side frame 16 is fixed to the upper side frame 15 in a state combined from the lower side.

The upper side frame 15 movably holds the IC contact block 11. The upper side frame 15 is formed with an opening part where a part of the IC contact block 11 is disposed. The opening part penetrates through the upper side frame 15 in the upper-lower direction and leads to the card moving passage 6. The upper cover 17 closes the opening part from the upper side and covers the IC contact block 11 from the upper side. A further specific structure of the main body frame 7 will be described below.

The circuit board 13 is a rigid board such as a glass epoxy board. The circuit board 13 is formed in a rectangular flat plate shape. The circuit board 13 is disposed on the upper side with respect to the upper side frame 15 and the upper cover 17. A thickness direction of the circuit board 13 coincides with the upper-lower direction. The circuit board 13 is fixed to an upper end part of the upper side frame 15. The circuit board 13 covers the card accommodating part 7b from the upper side.

The printed board 14 is a flexible printed board. The printed board 14 is formed with a detective circuit for detecting at least one of its own disconnection and its own short-circuit. The detection circuit is formed over a substantially entire area of the printed board 14. The printed board 14 is connected with the circuit board 13. The printed board 14 covers the card accommodating part 7b from both sides in the left-right direction, the lower side and the rear side. The printed board 14 is structured of a first board part 14b in a rectangular shape which is disposed on outer sides in the left-right direction of the card accommodating part 7b, a second board part 14c (see FIG. 5) in a rectangular shape which is disposed on the lower side of the card accommodating part 7b, and a third board part 14d in a rectangular shape which is disposed on the rear side of the card accommodating part 7b. A thickness direction of the first board part 14b coincides with the left-right direction. A thickness direction of the second board part 14c coincides with the upper-lower direction, and a thickness direction of the third board part 14d coincides with the front-rear direction.

The IC contact block 11 is movable with respect to the upper side frame 15 between a contact position where the IC contact springs can be in contact with an external connection terminal 3b of a card 3 and an evacuation position which is a position where the IC contact springs are evacuated so as not to be in contact with the external connection terminal 3b. The IC contact block 11 is energized toward the evacuation position by a spring member such as a torsion coil spring. When a card 3 is not inserted into the card reader 2, the IC contact block 11 is disposed at the evacuation position.

When a card 3 is inserted into the card reader 2, the card 3 moved along the card moving passage 6 toward the rear side is in contact with the IC contact block 11 and the IC contact block 11 is moved from the evacuation position to the contact position. When the IC contact block 11 reaches the contact position, the IC contact springs are in contact with an external connection terminal 3b under a predetermined contact pressure, and reading of data recorded in the card 3 and/or recording of data to the card 3 are performed. Further, when the card 3 inserted into the card reader 2 is pulled out, the IC contact block 11 located at the contact position is moved to the evacuation position by an energizing force of the spring member.

The main case body 10 is formed in a rectangular parallelepiped box shape whose front end is opened. The card accommodating part 7b, the IC contact block 11, the circuit board 13 and the printed board 14 are accommodated in an inside of the main case body 10. A front end part of the main case body 10 is formed in a flange shape. The main case body 10 is attached to the main body frame 7. Specifically, the front end part of the main case body 10 is fixed to a rear face of the partition part 7c. The bezel 9 is attached to a front side portion of the main body frame 7. Specifically, a rear end part of the bezel 9 is fixed to a front face of the partition part 7c. A specific structure of the bezel 9 will be described below.

In this embodiment, an area on the rear side with respect to the partition part 7c and an outer side of the card accommodating part 7b, which is an area surrounded by the partition part 7c and the main case body 10, is structured to be a waterproof area which prevents liquid such as water from entering. The circuit board 13 is disposed on the upper side with respect to the upper side frame 15 and the upper cover 17 and is disposed in an inside of the waterproof area. On the other hand, an area in an inside of the card accommodating part 7b including the card moving passage 6 and an area on the front side with respect to the partition part 7c are structured to be a water-entering permission area which permits entry of liquid such as water. The upper cover 17 and the lower cover 18 function as a liquid-proof cover which prevents liquid entering from an inside of the card accommodating part 7b to the waterproof area.

### (Structure of Main Body Frame)

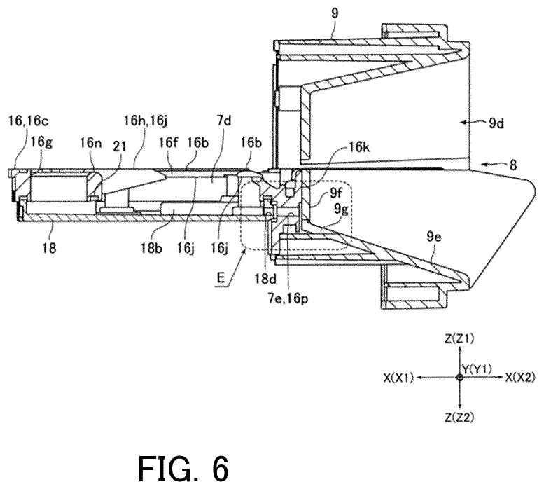

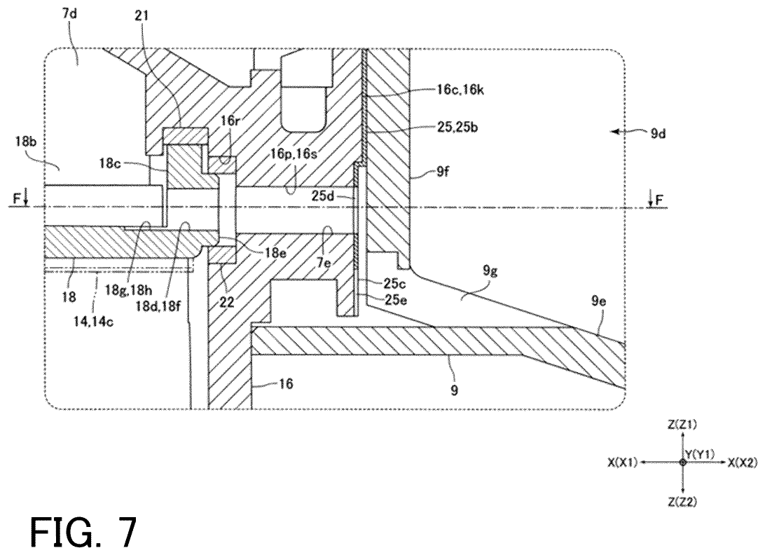

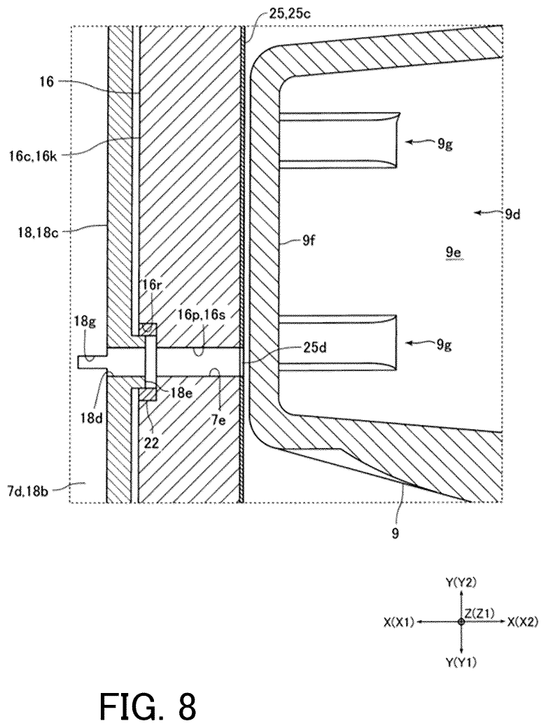

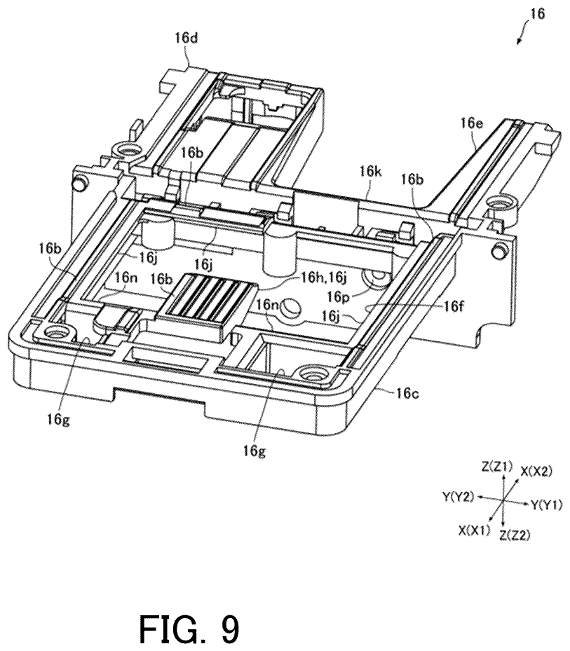

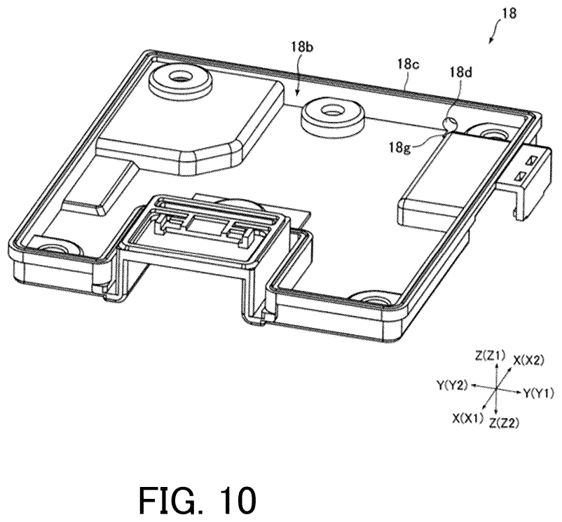

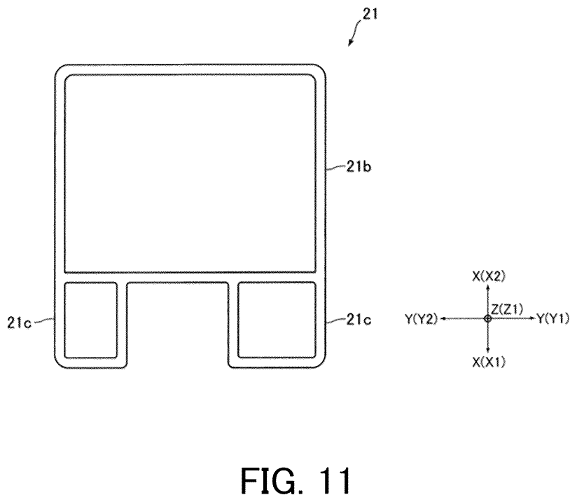

FIG. 6 is a cross-sectional view showing the bezel 9, the lower side frame 16 and the lower cover 18 and the like shown in FIG. 4. FIG. 7 is an enlarged view showing the “E”-part in FIG. 6. FIG. 8 is a cross-sectional view showing the “F-F” cross section in FIG. 7. FIG. 9 is a perspective view showing the lower side frame 16 in FIG. 6. FIG. 10 is a perspective view showing the lower cover 18 in FIG. 6. FIG. 11 is a plan view showing a sealing member 21 in FIG. 7.

As described above, the lower side frame 16 is formed with a lower face of the card moving passage 6. In other words, the main body frame 7 is formed with a moving passage forming face 16b which is a lower side face of the card moving passage 6. The IC contact block 11 is disposed on the upper side with respect to the moving passage forming face 16b. The lower side frame 16 in this embodiment is a first frame which is formed with the moving passage forming face 16b.

Further, the main body frame 7 is formed with a receiving part 7d which is recessed toward the lower side from the moving passage forming face 16b, and a liquid discharge passage 7e for discharging liquid such as water accumulated in the receiving part 7d to the outside of the card reader 2. As described above, the Z2-direction side (lower side) of the card reader 2 almost coincides with the lower side in the vertical direction (side where gravity acts). The receiving part 7d is disposed on the lower side in the vertical direction with respect to a card 3 which is in contact with the moving passage forming face 16b. The liquid discharge passage 7e is a through hole leading from the receiving part 7d to an end face on the front side of the main body frame 7.

The receiving part 7d is a storage space for storing a foreign matter inserted from the card insertion slot 8. The receiving part 7d is capable of storing a foreign matter inserted from the card insertion slot 8. A foreign matter which is inserted from the card insertion slot 8 is, for example, a coin, a cracked card, a broken piece of a card or a receipt.

The lower side frame 16 is provided with a frame base part 16c which structures a portion on the lower side of the card accommodating part 7b, a protruding part 16d which structures a lower side portion of the head arrangement part 7g of the main body frame 7, and a protruding part 16e which structures a lower side portion of the card guide part 7h of the main body frame 7. The protruding parts 16d and 16e protrude from the frame base part 16c to the front side. The protruding part 16d and the protruding part 16e are disposed with a space therebetween in the left-right direction.

An outward shape of the frame base part 16c when viewed in the upper-lower direction is a rectangular shape whose long side direction is the front-rear direction. A width in the left-right direction of the frame base part 16c is wider than a width of a card 3. The frame base part 16c is formed with one opening part 16f and two opening parts 16g which penetrate through the frame base part 16c in the upper-lower direction. The two opening parts 16g are formed in a rear end part of the frame base part 16c. The two opening parts 16g are disposed with a space therebetween in the left-right direction.

The opening part 16f is formed on the front side with respect to the two opening parts 16g. A size of the opening part 16f is larger than a size of the opening part 16g. A wall part 16n is formed between the opening part 16f and the opening parts 16g. The opening part 16f is formed between a right end part and a left end part of the frame base part 16c. Further, the opening part 16f is formed to a front end part of the frame base part 16c. A shape of the opening part 16f when viewed in the upper-lower direction is a rectangular shape. The opening part 16f structures an upper side portion of the receiving part 7d.

The frame base part 16c is provided with a facing part 16h which faces the IC contact block 11 from the lower side. The facing part 16h functions to increase contact pressure between the IC contact springs 8 and a card 3. The facing part 16h protrudes toward the front side between the two opening parts 16g in the left-right direction. Further, the facing part 16h protrudes to the front side with respect to the wall part 16n and protrudes to an inside of the opening part 16f.

The front side with respect to the facing part 16h is a part of the receiving part 7d, and the part of the receiving part 7d is disposed on the front side with respect to the facing part 16h which faces the IC contact block 11. In other words, a part of the receiving part 7d is disposed on the front side with respect to the IC contact block 11. Further, when viewed in the upper-lower direction, a part of the receiving part 7d is disposed on both sides in the left-right direction with respect to the IC contact block 11. In this embodiment, a part of the receiving part 7d is not disposed on the rear side with respect to the IC contact block 11.

The moving passage forming face 16b is formed on a front right side with respect to the opening part 16f. Further, the moving passage forming face 16b is also formed on both sides in the left-right direction with respect to the opening part 16f. The portion of the frame base part 16c disposed on the front right side with respect to the opening part 16f and its portions disposed on both sides in the left-right direction with respect to the opening part 16f are formed as a moving passage forming part 16j where the moving passage forming face 16b is formed. Further, the moving passage forming face 16b is also formed on an upper face of the facing part 16h. The facing part 16h in this embodiment is also the moving passage forming part 16j where the moving passage forming face 16b is formed. As described above, in the lower side frame 16, at least a part of the portion where the opening part 16f is not formed is structured as the moving passage forming part 16j where the moving passage forming face 16b is formed.

A portion in a front end part of the frame base part 16c which is disposed between the protruding part 16d and the protruding part 16e in the left-right direction is a front wall part 16k of the lower side frame 16. In other words, the lower side frame 16 is provided with the front wall part 16k. The front wall part 16k is disposed on the front side with respect to the opening part 16f. A lower end of the front wall part 16k is disposed on the lower side with respect to lower ends of the protruding parts 16d and 16e. The front wall part 16k is formed with a liquid discharge passage 16p as a second liquid discharge passage which structures a part of the liquid discharge passage 7e. The liquid discharge passage 16p is a circular hole-shaped through hole which penetrates through the front wall part 16k in the front-rear direction. The liquid discharge passage 16p is structured of a large diameter part 16r which structures a rear end part of the liquid discharge passage 16p, and a small diameter part 16s whose diameter is smaller than the large diameter part 16r. The small diameter part 16s is connected with a front end of the large diameter part 16r.

The lower cover 18 is formed in a substantially rectangular parallelepiped box shape whose upper face side is opened. Further, the lower cover 18 is formed in a flat box shape whose thickness in the upper-lower direction is thin. An outward shape of the lower cover 18 when viewed in the upper-lower direction is a rectangular shape whose long side direction is the front-rear direction. The lower cover 18 is fixed to the lower side of the frame base part 16c so as to cover the frame base part 16c from the lower side. The opening parts 16f and 16g are covered by the lower cover 18 from the lower side. The lower cover 18 is fixed to the frame base part 16c by a screw. Therefore, the lower cover 18 can be easily attached and detached to and from the frame base part 16c.

A portion which is an inner side portion of the lower cover 18 formed in a box shape and is disposed on the front side with respect to the wall part 16n is formed to be a first receiving part 18b structuring a lower side portion of the receiving part 7d. In other words, the first receiving part 18b is formed in the lower cover 18. The receiving part 7d is structured of the opening part 16f and the first receiving part 18b. The lower cover 18 in this embodiment is a receiving part forming member which is formed with the first receiving part 18b and is fixed to the lower side of the lower side frame 16.

A right end of the first receiving part 18b is disposed on the right side with respect to a right end of the opening part 16f, and a right end part (a part on a right end side) of the first receiving part 18b is disposed on the lower side of the moving passage forming part 16j which is disposed on the right side of the opening part 16f. A left end of the first receiving part 18b is disposed on the left side with respect to a left end of the opening part 16f, and a left end part (a part on a left end side) of the first receiving part 18b is disposed on the lower side of the moving passage forming part 16j disposed on the left side of the opening part 16f. A front end of the first receiving part 18b is disposed on the front side with respect to a front end of the opening part 16f, and a front end part (a part on a front end side) of the first receiving part 18b is disposed on the lower side of the moving passage forming part 16j which is disposed on the front right side of the opening part 16f. Further, a lower side of the facing part 16h is also the first receiving part 18b, and a part of the first receiving part 18b is disposed on the lower side with respect to the facing part 16h which is also the moving passage forming part 16j.

A lower face (bottom face) of the first receiving part 18b is a flat face perpendicular to the upper-lower direction. In other words, a lower face of the receiving part 7d is a flat face perpendicular to the upper-lower direction. The lower cover 18 is provided with a front wall part 18c as a first front wall part which structures a front side face of the lower cover 18. The front wall part 18c is disposed on the rear side of the front wall part 16k of the lower side frame 16. In other words, the front wall part 16k is disposed on the front side of the front wall part 18c. The front wall part 16k in this embodiment is a second front wall part which is disposed on the front side of the front wall part 18c.

The front wall part 18c is formed with a liquid discharge passage 18d as a first liquid discharge passage which structures a part of the liquid discharge passage 7e. The liquid discharge passage 18d is a through hole in a circular hole shape which penetrates through the front wall part 18c in the front-rear direction. The liquid discharge passage 7e is structured of the liquid discharge passage 18d and the liquid discharge passage 16p. The liquid discharge passage 18d structures a rear side portion of the liquid discharge passage 7e, and the liquid discharge passage 16p structures a front side portion of the liquid discharge passage 7e. An inner diameter of the liquid discharge passage 18d is set to be slightly smaller than an inner diameter of the small diameter part 16s of the liquid discharge passage 16p. A center of the liquid discharge passage 18d formed in a circular hole shape and a center of the liquid discharge passage 16p formed in a circular hole shape are coincided with each other.

A portion of the front wall part 18c where the liquid discharge passage 18d is formed is formed with a protruded part 18e in a cylindrical shape which protrudes toward the front side. A front end part of the liquid discharge passage 18d structures an inner circumferential face of the protruded part 18e. A front end part of the protruded part 18e is disposed on an inner peripheral side of a rear end part of the large diameter part 16r of the liquid discharge passage 16p. A lower end 18f (see FIG. 7) of the liquid discharge passage 18d is disposed on the lower side with respect to a lower face of the receiving part 7d which is formed in a flat face shape. More specifically, the lower end 18f of the liquid discharge passage 18d is disposed on the lower side in the vertical direction with respect to the lower face of the receiving part 7d. The lower end 18f in this embodiment is a first discharge passage end which is an end on the first direction side of the liquid discharge passage 18d which is the first liquid discharge passage.

The lower cover 18 is formed with a recessed part 18g which is disposed on the rear side of the liquid discharge passage 18d and is connected to the liquid discharge passage 18d. The recessed part 18g is recessed from a lower face of the receiving part 7d toward the lower side. The recessed part 18g is formed in a straight shape which is extended from a rear end of the liquid discharge passage 18d to the rear side. A side face of the recessed part 18g when viewed in the front-rear direction is formed in a circular arc shape. A lower end 18h (see FIG. 7) of the recessed part 18g is disposed at the same position as the lower end 18f of the liquid discharge passage 18d in the upper-lower direction.

Sealing members 21 and 22 for preventing leakage of liquid from a portion between the lower side frame 16 and the lower cover 18 are disposed between the lower side frame 16 and the lower cover 18. The sealing member 21 is packing made of rubber. The sealing member 21 is disposed between the lower side frame 16 and the lower cover 18 in the upper-lower direction. As shown in FIG. 11, the sealing member 21 is, when viewed in the upper-lower direction, structured of a first sealing member 21b in a rectangular ring shape, which surrounds the opening part 16f, and two second sealing members 21c in a rectangular ring shape which surround the opening parts 16g.

The sealing member 22 is packing made of rubber. The sealing member 22 is formed in a ring shape. The sealing member 22 is disposed in an inside of the large diameter part 16r of the liquid discharge passage 16p. The sealing member 22 is, for example, in contact with an outer peripheral face of the protruded part 18e and an inner peripheral face of the large diameter part 16r at a predetermined contact pressure. The sealing member 22 functions to prevent leakage of liquid from a connecting portion of the liquid discharge passage 18d with the liquid discharge passage 16p. In this embodiment, the sealing member 22 may be in contact with a front end face of the protruded part 18e and a front face of the large diameter part 16r at a predetermined contact pressure.

### (Structure of Bezel)

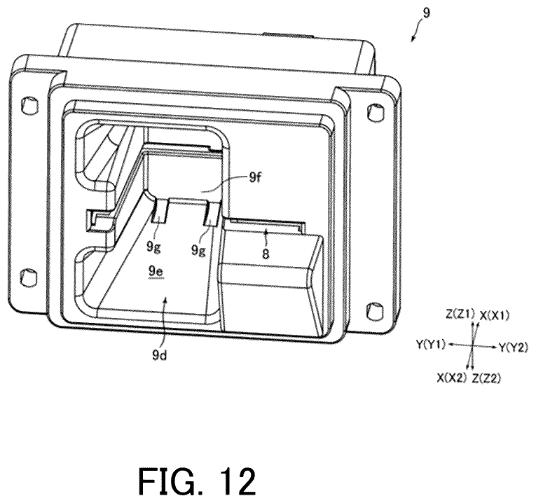

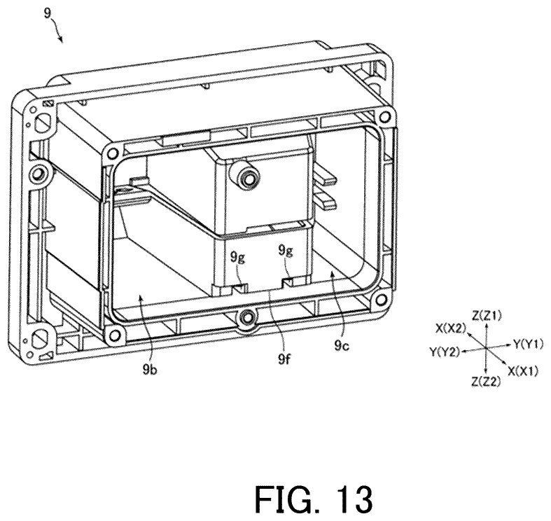

FIG. 12 is a perspective view showing the bezel 9 in FIG. 6. FIG. 13 is a perspective view showing the bezel 9 in FIG. 12 which is viewed in a different direction.

As described above, a rear end part of the bezel 9 is fixed to a front face of the partition part 7c. The bezel 9 structures a front face of the card reader 2. The bezel 9 covers the head arrangement part 7g and the card guide part 7h of the main body frame 7. The bezel 9 is formed with an arrangement recessed part 9b where the head arrangement part 7g is disposed and an arrangement recessed part 9c where the card guide part 7h is disposed (see FIG. 13). The arrangement recessed parts 9b and 9c are recessed toward the front side from a rear face of the bezel 9. The arrangement recessed part 9b and the arrangement recessed part 9c are disposed with a space therebetween in the left-right direction.

Further, the bezel 9 is formed with a finger insertion part 9d which is recessed toward the rear side from a front side face (front face) of the bezel 9. The finger insertion part 9d is formed between the arrangement recessed part 9b and the arrangement recessed part 9c in the left-right direction. The finger insertion part 9d is formed in a size capable of inserting fingers of a user who utilizes the card reader 2. Fingers of a user are inserted to the finger insertion part 9d when a card 3 is inserted into the card reader 2 and when the card 3 is pulled out from the card reader 2. A lower face of the finger insertion part 9d is formed in an inclined face 9e which inclines toward the lower side as going to the front side.

A portion on the rear side and the lower side of the finger insertion part 9d is a front side arrangement part 9f which is disposed on the front side with respect to the liquid discharge passage 7e. In other words, the bezel 9 is provided with the front side arrangement part 9f. The front side arrangement part 9f is disposed on the front side with respect to the front wall part 16k. A space is formed between the front wall part 16k and the front side arrangement part 9f in the front-rear direction. The front side arrangement part 9f is formed with a cover side liquid discharge passage 9g which is a through hole for discharging liquid. In this embodiment, two cover side liquid discharge passages 9g are formed with a space therebetween in the left-right direction.

The cover side liquid discharge passage 9g is formed in a rectangular hole shape penetrating through the front side arrangement part 9f in the front-rear direction. A lower face of the cover side liquid discharge passage 9g is a flat face perpendicular to the upper-lower direction. As shown in FIG. 7, a lower face of the cover side liquid discharge passage 9g is connected to the inclined face 9e. Further, as shown in FIG. 7, the cover side liquid discharge passage 9g is disposed on the lower side with respect to the liquid discharge passage 7e. More specifically, the cover side liquid discharge passage 9g is disposed on the lower side in the vertical direction with respect to the liquid discharge passage 7e.

### (Structure of Printed Board)

The card reader main body 4 includes a printed board 24 as a second printed board which is connected with the magnetic head 12, and a printed board 25 which is disposed on the front side with respect to the receiving part 7d of the main body frame 7 (see FIG. 5). The magnetic head 12 is disposed on the front side with respect to the receiving part 7d. The printed boards 24 and 25 are flexible printed boards. Further, the printed board 24 and the printed board 25 are integrally formed with each other. In other words, the printed boards 24 and 25 are a flexible printed board which is integrally formed with each other. In FIG. 6, the printed board 25 is not shown.

The printed board 24 is formed with a detection circuit for detecting at least one of its own disconnection and its own short circuit. The detection circuit is formed in a substantially entire area of the printed board 24. The printed board 24 is extended toward the rear side from the magnetic head 12. The printed board 24 is connected with the circuit board 13. The lower side frame 16 is formed with a through hole for extending the printed board 24 to the rear side with respect to the partition part 7c.

The printed board 25 is formed with a detection circuit for detecting at least one of its own disconnection and its own short circuit. The detection circuit is formed in a substantially entire area of the printed board 25. The printed board 25 is connected to a left end part of the printed board 24. The printed board 25 is extended toward the left side from the printed board 24. The printed board 25 is disposed between the receiving part 7d and the card insertion slot 8 in the front-rear direction. Further, the printed board 25 is disposed between the main body frame 7 and the bezel 9 in the front-rear direction. Specifically, the printed board 25 is disposed between the front wall part 16k and the front side arrangement part 9f in the front-rear direction.

The printed board 25 is fixed to a front face of the front wall part 16k. The printed board 25 is, for example, fixed to the front face of the front wall part 16k by a double-sided tape. A thickness direction of the printed board 25 coincides with the front-rear direction. The printed board 25 is structured of a first board part 25b disposed between the protruding part 16d and the protruding part 16e and a second board part 25c which is connected with a lower end of the first board part 25b. The first board part 25b and the second board part 25c are formed in a long and thin rectangular shape in the left-right direction.

A length in the left-right direction of the second board part 25c is longer than a length in the left-right direction of the first board part 25b. A right end part of the second board part 25c is connected with a left end part of the printed board 24. An upper end of the printed board 25 (in other words, an upper end of the first board part 25b) is disposed on a slightly lower side with respect to the card moving passage 6. A lower end of the printed board 25 (in other words, a lower end of the second board part 25c) is disposed on the lower side with respect to a lower face of the receiving part 7d. Further, the lower end of the printed board 25 is disposed on the lower side with respect to a lower face of the second board part 14c of the printed board 14 (see FIG. 7). Further, the lower end of the printed board 25 is disposed between an upper face and a lower face of the cover side liquid discharge passage 9g in the upper-lower direction.

A portion of the printed board 25 which overlaps with the liquid discharge passage 7e in the front-rear direction (portion overlapping with the liquid discharge passage 16p) is formed with a liquid discharge hole 25d penetrating through the printed board 25 in the front-rear direction. Further, a portion of the printed board 25 overlapping with the cover side liquid discharge passage 9g in the front-rear direction is formed with a cut-out part 25e. The liquid discharge hole 25d and the cut-out part 25e are formed in the second board part 25c. Liquid discharge hole 25d is a circular hole penetrating through the second board part 25c in the front-rear direction. The cut-out part 25e is cut out from a lower end of the second board part 25c toward the upper side. The cut-out part 25e is formed at two positions with a space therebetween in the left-right direction.

### Principal Effects in this Embodiment

As described above, in this embodiment, the main body frame 7 is formed with the receiving part 7d which is recessed from the moving passage forming face 16b that is a face on the lower side of the card moving passage 6 toward the lower side and is disposed on the lower side in the vertical direction with respect to a card 3 which is in contact with the moving passage forming face 16b. Therefore, according to this embodiment, a foreign matter inserted from the card insertion slot 8 can be dropped to the receiving part 7d and accommodated in the receiving part 7d. Accordingly, in this embodiment, even when a foreign matter is inserted from the card insertion slot 8, clogging of the card moving passage 6 due to the foreign matter is prevented and subsequent transactions of a card 3 can be continued in the card reader 2.

In this embodiment, the main body frame 7 is formed with the liquid discharge passage 7e for discharging liquid accumulated in the receiving part 7d from the receiving part 7d to the outside of the card reader 2. Therefore, according to this embodiment, the liquid accumulated in the receiving part 7d can be discharged to the outside of the card reader 2 by utilizing the liquid discharge passage 7e. Accordingly, in this embodiment, even when the receiving part 7d is formed in the main body frame 7, occurrence of trouble of the card reader 2 due to liquid accumulated in an inside of the card reader 2 can be suppressed.

In this embodiment, the lower end 18f of the liquid discharge passage 18d is disposed on the lower side in the vertical direction with respect to a lower face of the receiving part 7d formed in a flat face shape. Therefore, according to this embodiment, liquid accumulated in the receiving part 7d is easily flowed toward the liquid discharge passage 18d by gravity. Accordingly, in this embodiment, liquid accumulated in the receiving part 7d is easily discharged from the liquid discharge passage 18d. Further, in this embodiment, the lower case 18 is formed with the recessed part 18g connected with a rear end of the liquid discharge passage 18d, and the lower end 18h of the recessed part 18g is disposed at the same position as the lower end 18f of the liquid discharge passage 18d in the upper-lower direction. Therefore, according to this embodiment, liquid accumulated in the receiving part 7d can be easily guided to the liquid discharge passage 18d by utilizing the recessed part 18g.

In this embodiment, the liquid discharge passage 7e is a through hole leading from the receiving part 7d to an end face on the front side of the main body frame 7. Further, in this embodiment, the front side arrangement part 9f of the bezel 9 which is disposed on the front side of the liquid discharge passage 7e is formed with the cover side liquid discharge passage 9g. Therefore, according to this embodiment, liquid accumulated in the receiving part 7d can be discharged to the outside on the front side of the card reader 2 which is formed with the card insertion slot 8 by utilizing the liquid discharge passage 7e and the cover side liquid discharge passage 9g. Especially, in this embodiment, a lower face of the cover side liquid discharge passage 9g is connected with the inclined face 9e of the finger insertion part 9d and thus, the liquid discharged from the cover side liquid discharge passage 9g is easily discharged to the outside on the front side of the card reader 2. Therefore, according to this embodiment, even when the card reader 2 is attached to a predetermined host apparatus, liquid can be easily discharged to the outside of the host apparatus

In this embodiment, the cover side liquid discharge passage 9g is disposed on the lower side in the vertical direction with respect to the liquid discharge passage 7e. Therefore, according to this embodiment, liquid which is discharged from the liquid discharge passage 7e can be easily flowed toward the cover side liquid discharge passage 9g by gravity. Accordingly, in this embodiment, liquid discharged from the liquid discharge passage 7e can be easily discharged to the outside of the card reader 2 through the cover side liquid discharge passage 9g. Further, in this embodiment, the cover side liquid discharge passage 9g is disposed on the lower side in the vertical direction with respect to the liquid discharge passage 7e and thus, even when liquid flows backward toward the rear side in the cover side liquid discharge passage 9g, the liquid flowing backward can be prevented from entering into the liquid discharge passage 7e.

In this embodiment, a part of the receiving part 7d is disposed on the front side with respect to the IC contact block 11. Therefore, according to this embodiment, for example, in comparison with a case that the receiving part 7d is disposed on the rear side with respect to the IC contact block 11, a foreign matter inserted from the card insertion slot 8 can be easily dropped to the receiving part 7d.

In this embodiment, a part of the first receiving part 18b structuring a lower side portion of the receiving part 7d is disposed on the lower side with respect to the moving passage forming part 16j, and the lower side of the moving passage forming part 16j is also a part of the first receiving part 18b. Therefore, according to this embodiment, a size of the receiving part 7d can be increased. Accordingly, in this embodiment, a large foreign matter can be accommodated in the receiving part 7d, and many foreign matters can be accommodated in the receiving part 7d.

In this embodiment, the receiving part 7d which is recessed toward the lower side from the moving passage forming face 16b that is a lower side face of the card moving passage 6 is formed in the main body frame 7. Therefore, data including secret information may be illegally acquired by a criminal who has performed illegal trick on the receiving part 7d from the front side of the card reader 2. However, in this embodiment, the printed board 25 which is formed with a detection circuit for detecting at least one of its own disconnection and its own short circuit is disposed on the front side with respect to the receiving part 7d.

Therefore, according to this embodiment, when a criminal performs some illegal trick on the receiving part 7d from the front side of the card reader 2, the detection circuit of the printed board 25 is disconnected or short-circuited. Therefore, in this embodiment, in a case that disconnection or short circuit of the detection circuit of the printed board 25 is detected, when predetermined processing such as making the card reader 2 unusable is performed, data including secret information can be prevented from being illegally acquired.

In this embodiment, the printed board 25 is a flexible printed board. Therefore, in this embodiment, an installation space of the printed board 25 can be narrowed and the printed board 25 can be easily installed. Further, in this embodiment, the printed board 25 is fixed to a front face of the front wall part 16k and thus, when a criminal has performed some illegal trick on the receiving part 7d from the front side of the card reader 2, the printed board 25 can be prevented from moving to the rear side. Therefore, according to this embodiment, when a criminal has performed some illegal trick on the receiving part 7d from the front side of the card reader 2, the detection circuit of the printed board 25 is easily disconnected or short-circuited.

In this embodiment, a portion of the printed board 25 overlapping with the liquid discharge passage 7e in the front-rear direction is formed with the liquid discharge hole 25d penetrating through the printed board 25 in the front-rear direction. Therefore, according to this embodiment, even when the printed board 25 is fixed to a front face of the front wall part 16k, liquid accumulated in the receiving part 7d can be discharged to the outside on the front side of the card reader 2. Further, in this embodiment, a portion of the printed board 25 overlapping with the cover side liquid discharge passage 9g in the front-rear direction is formed with the cut-out part 25e. Therefore, according to this embodiment, mischief can be prevented, for example, like a case that a ball-point pen or the like is inserted into the cover side liquid discharge passage 9g from the front side of the card reader 2 to disconnect the detection circuit formed in the printed board 25.

In this embodiment, the printed boards 24 and 25 are flexible printed boards which are integrally formed with each other. Therefore, according to this embodiment, in comparison with a case that the printed board 25 disposed on the front side with respect to the receiving part 7d and the printed board 24 extended from the magnetic head 12 are formed separately, structure of the card reader 2 can be simplified. Further, in this embodiment, a lower end of the printed board 25 is disposed on the lower side with respect to a lower face of the receiving part 7d. Therefore, even when a criminal performs a certain illegal trick from obliquely lower front side of the card reader 2 to the receiving part 7d, the detection circuit of the printed board 25 can be disconnected or short-circuited.

### OTHER EMBODIMENTS

Although the present invention has been shown and described with reference to a specific embodiment, various changes and modifications will be apparent to those skilled in the art from the teachings herein.

In the embodiment described above, the card reader 2 may include a sensor for detecting entering of a foreign matter to the receiving part 7d. In this case, based on a detection result of the sensor, a timing for taking out the foreign matter from the receiving part 7d can be notified to an owner of the card reader 2. Further, in the embodiment described above, the entire receiving part 7d may be disposed on the front side with respect to the IC contact block 11. Further, at least a part of the receiving part 7d may be disposed on the rear side with respect to the IC contact block 11. In addition, in the embodiment described above, the lower side of the moving passage forming part 16j may not be provided with a part of the first receiving part 18b. Further, in the embodiment described above, the liquid discharge passage 7e and the cover side liquid discharge passage 9g may be disposed at the same position in the vertical direction. Further, in the embodiment described above, the card reader 2 may include no bezel 9.

In the embodiment described above, the lower end 18h of the recessed part 18g may be disposed on the upper side with respect to the lower end 18f of the liquid discharge passage 18d. Further, in the embodiment described above, the lower cover 18 may be formed with no recessed part 18g. In this case, the lower end 18f of the liquid discharge passage 18d may be disposed at the same position as a lower face of the receiving part 7d in the upper-lower direction. In addition, in the embodiment described above, the lower side frame 16 may be formed with no front wall part 16k. In this case, the liquid discharge passage 18d structures the liquid discharge passage 7e. Further, the lower cover 18 may be formed with no front wall part 18c. In this case, the liquid discharge passage 16p structures the liquid discharge passage 7e.

In the embodiment described above, the card reader 2 may be provided with a communication antenna for communicating data with a card 3 instead of the IC contact block 11. In this case, for example, a part of the receiving part 7d is disposed on the front side with respect to the communication antenna. The communication antenna in this embodiment is at least a data reading mechanism for reading data recorded in a card 3.

In the embodiment described above, the card reader 2 is a manual type card reader. However, the card reader 2 may be a card conveyance-type card reader having a card conveyance mechanism which automatically conveys a card 3. In this case, for example, the card reader 2 may include no IC contact block 11. In this case, for example, a part of the receiving part 7d is disposed on the front side with respect to a magnetic head 12. The magnetic head 12 in this case is at least a data reading mechanism for reading data recorded in a card 3.

In the embodiment described above, the liquid discharge passage 7e may be a through hole penetrating from the receiving part 7d to an end face on the lower side, end faces in the left-right direction or an end face on the rear side of the main body frame 7. Further, in the embodiment described above, the card reader main body 4 may include no magnetic head 12. Further, in the embodiment described above, a PET (polyethylene terephthalate) card whose thickness is about 0.18-0.36 mm, a paper card having a predetermined thickness, a card made of metal or the like may be processed in the card reader 2.

In the embodiment described above, the printed board 24 and the printed board 25 may be formed separately from each other. In this case, the printed board 25 is extended to the rear side so as to be connected with the circuit board 13. Further, in the embodiment described above, the printed board 25 may be integrally formed with the printed board 14. In addition, in the embodiment described above, the printed board 25 may be fixed to rear faces of the front wall parts 16k and 18c. Also in this case, the printed board 25 is disposed on the front side with respect to the receiving part 7d.

In the embodiment described above, a portion between the two cut-out parts 25e of the printed board 25 may be cut out so that two cut-out parts 25e are connected with each other. Further, in the embodiment described above, no cut-out part 25e may be formed in the printed board 25. In addition, in the embodiment described above, the printed board 25 may be a rigid board. Further, in the embodiment described above, a front face of a portion of the upper side frame 15 between the head arrangement part 7g and the card guide part 7h may be disposed with a printed board in which a detection circuit for detecting at least one of its own disconnection and its own short circuit is formed. Further, in the embodiment described above, the main body frame 7 may be formed with no liquid discharge passage 7e.

### Technical Structure

Embodiments of the present invention may be structured as follows.
(1) In a card reader for performing at least one of reading of data recorded in a card and recording of data to the card,
the card reader includes a main body frame which is formed with a card moving passage where the card inserted from a card insertion slot is moved,
in a case that one side in a moving direction of the card which is linearly moved in the card moving passage is referred to as a front side, the opposite side to the front side is referred to as a rear side, and one side in a thickness direction of the card which is moved in the card moving passage is referred to as a first direction side,
the card is inserted into the card insertion slot from the front side toward the rear side, and
the main body frame is formed with a moving passage forming face which is a face on the first direction side of the card moving passage, a receiving part which is recessed from the moving passage forming face toward the first direction side and is disposed on a lower side in a vertical direction with respect to the card which is in contact with the moving passage forming face, and a liquid discharge passage for discharging liquid accumulated in the receiving part to an outside of the card reader from the receiving part.
(2) The card reader described in the above-mentioned structure (1), where the liquid discharge passage is a through hole leading from the receiving part to an end face on the front side of the main body frame.
(3) The card reader described in the above-mentioned structure (2), where
the main body frame includes a first frame which is formed with the moving passage forming face, and a receiving part forming member which is formed with a first receiving part structuring a portion on the first direction side of the receiving part and is fixed to the first direction side of the first frame,
when the opposite side to the first direction side is referred to as a second direction side, the first frame is formed with an opening part structuring a portion on the second direction side of the receiving part,
a sealing member for preventing leakage of liquid from a portion between the first frame and the receiving part forming member is disposed between the first frame and the receiving part forming member,
the receiving part forming member is provided with a first front wall part structuring a front side face of the receiving part forming member,
the first frame is provided with a second front wall part disposed on the front side with respect to the first front wall part, and
the liquid discharge passage is structured of a first liquid discharge passage which penetrates through the first front wall part, and a second liquid discharge passage penetrating through the second front wall part.
(4) The card reader described in the above-mentioned structure (3), where a first liquid discharge passage end which is an end on the first direction side of the first liquid discharge passage is disposed on a lower side in the vertical direction with respect to a face on the first direction side of the receiving part which is formed in a flat face shape.
(5) The card reader described in the above-mentioned structure (4), where
the receiving part forming member is formed with a recessed part which is disposed on the rear side with respect to the first liquid discharge passage and is connected with the first liquid discharge passage and is recessed from a face on the first direction side of the receiving part toward the first direction side, and
an end on the first direction side of the recessed part is disposed at the same position as the first liquid discharge passage end in the thickness direction of the card.
(6) The card reader described in one of the above-mentioned structures (2) through (5), where
the card reader includes a front face cover which is formed with the card insertion slot and is attached to a front side portion of the main body frame,
the front face cover is provided with a front side arrangement part which is disposed on the front side with respect to the liquid discharge passage, and
the front side arrangement part is formed with a cover side liquid discharge passage which is a through hole for discharging liquid.
(7) The card reader described in the above-mentioned structure (6), where the cover side liquid discharge passage is disposed on a lower side in the vertical direction with respect to the liquid discharge passage.
(8) The card reader described in the above-mentioned structure (6) or (7), where
the front face cover is formed with a finger insertion part into which fingers of a user are inserted at a time of insertion of the card to the card reader and pulling-out of the card from the card reader,
the finger insertion part is recessed from a face on the front side of the front face cover toward the rear side,
a face on the first direction side of the finger insertion part is formed in an inclined face which is inclined toward the first direction side as going to the front side,
a portion on the rear side and the first direction side of the finger insertion part is the front side arrangement part, and
a face on the first direction side of the cover side liquid discharge passage is connected with the inclined face.
(9) The card reader described in one of the above-mentioned structures (1) through (8), where the card reader includes at least a data reading mechanism for reading data recorded in the card, and at least a part of the receiving part is disposed on the front side with respect to the data reading mechanism.
(10) The card reader described in the above-mentioned structure (9), where
the data reading mechanism is an IC contact block having a plurality of IC contact springs structured to be in contact with an external connection terminal of an IC chip formed in the card,
when an opposite side to the first direction side is referred to as a second direction side, the IC contact block is disposed on the second direction side with respect to the moving passage forming face,
the main body frame includes a first frame in which the moving passage forming face is formed, and a receiving part forming member which is formed with a first receiving part structuring a portion on the first direction side of the receiving part and is fixed to the first frame on the first direction side,
the first frame is formed with an opening part structuring a portion on the second direction side of the receiving part,
the first frame is provided with a facing part which faces the IC contact block from the first direction side, and
a part of the first receiving part is disposed on the first direction side with respect to the facing part.
(11) The card reader described in one of the above-mentioned structures (1) through (10), where
the main body frame includes a first frame which is formed with the moving passage forming face, and a receiving part forming member which is formed with a first receiving part structuring a portion on the first direction side of the receiving part and is fixed to the first frame on the first direction side,
when the opposite side to the first direction side is referred to as a second direction side, the first frame is formed with an opening part structuring a portion on the second direction side of the receiving part,
at least a part of a portion of the first frame where the opening part is not formed is formed to be a moving passage forming part where the moving passage forming face is formed, and
a part of the first receiving part is disposed on the first direction side with respect to the moving passage forming part.
(12) The card reader described in one of the above-mentioned structures (1) through (11), where the card reader includes a printed board which is disposed on the front side with respect to the receiving part, and the printed board is formed with a detection circuit for detecting at least one of its own disconnection and its own short circuit.
(13) The card reader described in the above-mentioned structure (12), where
the card reader includes a front face cover which is formed with the card insertion slot and is attached to a front side portion of the main body frame, and
the printed board is a flexible printed board and is disposed between the main body frame and the front face cover in the moving direction of the card.
(14) The card reader described in the above-mentioned structure (13), where
the liquid discharge passage is a through hole leading from the receiving part to an end face on the front side of the main body frame, and
a portion of the printed board overlapping with the liquid discharge passage in the moving direction of the card is formed with a liquid discharge hole penetrating through the printed board in the moving direction of the card.
(15) The card reader described in the above-mentioned structure (14), where
the front face cover is provided with a front side arrangement part which is disposed on the front side with respect to the liquid discharge passage,
the front side arrangement part is formed with a cover side liquid discharge passage which is a through hole for discharging liquid, and
a portion of the printed board overlapping with the cover side liquid discharge passage in the moving direction of the card is formed with a cut-out part.
(16) The card reader described in one of the above-mentioned structures (12) through (15), where
the card reader includes a magnetic head for performing at least one of reading of magnetic data recorded in the card and recording of magnetic data to the card, and a second printed board connected with the magnetic head,
the magnetic head is disposed on the front side with respect to the receiving part,
the second printed board is formed with a detection circuit for detecting at least one of its own disconnection and its own short circuit, and
the printed board and the second printed board are structured to be an integrally formed flexible printed board.

In the embodiment described above, for example, the liquid discharge passage is a through hole leading from the receiving part to an end face on the front side of the main body frame. In this case, the liquid accumulated in the receiving part can be discharged to the outside on the front side of the card reader which is formed with the card insertion slot. Therefore, for example, even when the card reader is attached to a predetermined host apparatus, liquid can be easily discharged to the outside of the host apparatus.

In the embodiment described above, for example, the main body frame includes a first frame which is formed with the moving passage forming face, and a receiving part forming member which is formed with a first receiving part structuring a portion on the first direction side of the receiving part and is fixed to the first direction side of the first frame and, when the opposite side to the first direction side is referred to as a second direction side, the first frame is formed with an opening part structuring a portion on the second direction side of the receiving part. A sealing member for preventing leakage of liquid from a portion between the first frame and the receiving part forming member is disposed between the first frame and the receiving part forming member. The receiving part forming member is provided with a first front wall part structuring a front side face of the receiving part forming member, the first frame is provided with a second front wall part disposed on the front side with respect to the first front wall part, and the liquid discharge passage is structured of a first liquid discharge passage which penetrates through the first front wall part, and a second liquid discharge passage penetrating through the second front wall part.

In the embodiment described above, it is preferable that a first liquid discharge passage end which is an end on the first direction side of the first liquid discharge passage is disposed on a lower side in the vertical direction with respect to a face on the first direction side of the receiving part which is formed in a flat face shape. According to this structure, liquid accumulated in the receiving part is easily flowed toward the first liquid discharge passage by gravity. Therefore, liquid accumulated in the receiving part is easily discharged from the first liquid discharge passage.

In the embodiment described above, it is preferable that the receiving part forming member is formed with a recessed part which is disposed on the rear side with respect to the first liquid discharge passage and is connected with the first liquid discharge passage and is recessed from a face on the first direction side of the receiving part toward the first direction side, and an end on the first direction side of the recessed part is disposed at the same position as an end of the first liquid discharge passage in the thickness direction of the card. According to this structure, liquid accumulated in the receiving part is easily guided to the first liquid discharge passage by utilizing the recessed part.

In the embodiment described above, the card reader, for example, includes a front face cover which is formed with the card insertion slot and is attached to a front side portion of the main body frame, the front face cover is provided with a front side arrangement part which is disposed on the front side with respect to the liquid discharge passage, and the front side arrangement part is formed with a cover side liquid discharge passage which is a through hole for discharging liquid. In this case, liquid accumulated in the receiving part can be discharged to the outside on the front side of the card reader by utilizing the liquid discharge passage and the cover side liquid discharge passage.

In the embodiment described above, it is preferable that the cover side liquid discharge passage is disposed on a lower side in the vertical direction with respect to the liquid discharge passage. According to this structure, liquid which is discharged from the liquid discharge passage can be easily flowed toward the cover side liquid discharge passage by gravity. Therefore, liquid discharged from the liquid discharge passage can be easily discharged to the outside of the card reader through the cover side liquid discharge passage. Further, according to this structure, even when liquid flows backward toward the rear side in the cover side liquid discharge passage, the liquid flowed backward can be prevented from entering into the liquid discharge passage.

In the embodiment described above, for example, the front face cover is formed with a finger insertion part into which fingers of a user are inserted at a time of insertion of the card to the card reader and pulling-out of the card from the card reader, the finger insertion part is recessed from a face on the front side of the front face cover toward the rear side, a face on the first direction side of the finger insertion part is formed in an inclined face which is inclined toward the first direction side as going to the front side, a portion on the rear side and the first direction side of the finger insertion part is the front side arrangement part, and a face on the first direction side of the cover side liquid discharge passage is connected with the inclined face. In this case, liquid discharged from the cover side liquid discharge passage is easily discharged to the outside on the front side of the card reader by utilizing the inclined face.

In the embodiment described above, it is preferable that the card reader includes at least a data reading mechanism for reading data recorded in the card, and at least a part of the receiving part is disposed on the front side with respect to the data reading mechanism. According to this structure, for example, in comparison with a case that the receiving part is disposed on the rear side with respect to the data reading mechanism, a foreign matter inserted from the card insertion slot is easily dropped to the receiving part.

In the embodiment described above, it is preferable that the data reading mechanism is an IC contact block having a plurality of IC contact springs structured to be in contact with an external connection terminal of an IC chip formed in the card and, when an opposite side to the first direction side is referred to as a second direction side, the IC contact block is disposed on the second direction side with respect to the moving passage forming face. The main body frame includes a first frame in which the moving passage forming face is formed, and a receiving part forming member which is formed with a first receiving part structuring a portion on the first direction side of the receiving part and is fixed to the first frame on the first direction side. The first frame is formed with an opening part structuring a portion on the second direction side of the receiving part, the first frame is provided with a facing part which faces the IC contact block from the first direction side, and a part of the first receiving part is disposed on the first direction side with respect to the facing part. According to this structure, the first direction side of the facing part is also a part of the first receiving part and thus, a size of the receiving part can be increased. Therefore, a large foreign matter can be accommodated in the receiving part and many foreign matters can be accommodated in the receiving part.

In the embodiment described above, it is preferable that the main body frame includes a first frame in which the moving passage forming face is formed, and a receiving part forming member which is formed with a first receiving part structuring a portion on the first direction side of the receiving part and is fixed to the first frame on the first direction side and, when an opposite side to the first direction side is referred to as a second direction side, the first frame is formed with an opening part structuring a portion on the second direction side of the receiving part, at least a part of a portion where the opening part is not formed in the first frame is formed to be a moving passage forming part where the moving passage forming face is formed, and a part of the first receiving part is disposed on the first direction side with respect to the moving passage forming part. According to this structure, the first direction side of the moving passage forming part is also a part of the first receiving part and thus, a size of the receiving part can be increased. Therefore, a large foreign matter can be accommodated in the receiving part and many foreign matters can be accommodated in the receiving part.

In the embodiment described above, it is preferable that the card reader includes a printed board which is disposed on the front side with respect to the receiving part, and the printed board is formed with a detection circuit for detecting at least one of its own disconnection and its own short circuit. In this embodiment, the receiving part which is recessed toward the first direction side from the moving passage forming face is formed in the main body frame. Therefore, data including secret information may be illegally acquired by a criminal who has performed illegal trick on the receiving part from a front side of the card reader. However, according to this structure, when a criminal has performed some illegal trick on the receiving part from a front side of the card reader, the detection circuit of the printed board can be easily disconnected or short-circuited. Therefore, in a case that disconnection or short circuit of the detection circuit is detected, when predetermined processing such as making the card reader unusable is performed, data including secret information can be prevented from being illegally acquired.

In the embodiment described above, it is preferable that the card reader includes a front face cover which is formed with the card insertion slot and is attached to a front side portion of the main body frame, and the printed board is a flexible printed board and is disposed between the main body frame and the front face cover in the moving direction of the card. According to this structure, the printed board is a flexible printed board and thus, an installation space of the printed board can be decreased and the printed board can be easily installed. Further, according to this structure, the main body frame is disposed on a rear side with respect to the printed board and thus, when a criminal has performed some illegal trick on the receiving part from a front side of the card reader, the printed board can be prevented from moving to a rear side. Therefore, when a criminal has performed some illegal trick on the receiving part from a front side of the card reader, the detection circuit can be easily disconnected or short-circuited.

In the embodiment described above, for example, the liquid discharge passage is a through hole leading from the receiving part to an end face on the front side of the main body frame, and a portion of the printed board overlapping with the liquid discharge passage in the moving direction of the card is formed with a liquid discharge hole penetrating through the printed board in the moving direction of the card. In this case, the liquid discharge passage is a through hole leading from the receiving part to an end face on the front side of the main body frame and thus, liquid accumulated in the receiving part can be discharged to the outside on the front side of the card reader which is formed with the card insertion slot. Therefore, for example, even when the card reader is attached to a predetermined host apparatus, liquid can be easily discharged to the outside of the host apparatus. Further, in this case, a portion of the printed board overlapping with the liquid discharge passage in the moving direction of the card is formed with a liquid discharge hole penetrating through the printed board in the moving direction of the card. Therefore, even when the printed board is disposed between the main body frame and the front face cover, the liquid accumulated in the receiving part can be discharged to the outside on the front side of the card reader.

In the embodiment described above, for example, the front face cover is provided with a front side arrangement part which is disposed on the front side with respect to the liquid discharge passage, the front side arrangement part is formed with a cover side liquid discharge passage which is a through hole for discharging liquid, and a portion of the printed board overlapping with the cover side liquid discharge passage in the moving direction of the card is formed with a cut-out part. In this case, the front side arrangement part is formed with the cover side liquid discharge passage and thus, liquid accumulated in the receiving part can be discharged to the outside on the front side of the card reader by utilizing the liquid discharge passage and the cover side liquid discharge passage. Further, in this case, a portion of the printed board overlapping with the cover side liquid discharge passage in the moving direction of the card is formed with a cut-out part. Therefore, for example, mischief can be prevented, for example, like a case that a ball-point pen or the like is inserted into the cover side liquid discharge passage from a front side of the card reader to disconnect the detection circuit formed in the printed board.

In the embodiment described above, the card reader includes, for example, a magnetic head for performing at least one of reading of magnetic data recorded in the card and recording of magnetic data to the card, and a second printed board connected with the magnetic head. The magnetic head is disposed on the front side with respect to the receiving part, the second printed board is formed with a detection circuit for detecting at least one of its own disconnection and its own short circuit, and the printed board and the second printed board are structured to be an integrally formed flexible printed board. In this case, the flexible printed board which is disposed on the front side with respect to the receiving part is integrally formed with the flexible printed board extended from the magnetic head and thus, in comparison with a case that the flexible printed board which is disposed on the front side with respect to the receiving part and the flexible printed board extended from the magnetic head are separately formed from each other, the structure of the card reader can be simplified.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A card reader structured to perform at least one of reading of data recorded in a card and recording of data to the card, the card reader comprising a main body frame which is formed with a card moving passage where the card inserted from a card insertion slot is moved;
wherein in a case that one side in a moving direction of the card which is linearly moved in the card moving passage is referred to as a front side, an opposite side to the front side is referred to as a rear side, and one side in a thickness direction of the card which is moved in the card moving passage is referred to as a first direction side, the card is inserted into the card insertion slot from the front side toward the rear side; and
the main body frame is formed with:
a moving passage forming face which is a face on the first direction side of the card moving passage;
a receiving part which is recessed from the moving passage forming face toward the first direction side and is disposed on a lower side in a vertical direction with respect to the card which is in contact with the moving passage forming face; and
a liquid discharge passage for discharging liquid accumulated in the receiving part from the receiving part to an outside of the card reader.

2. The card reader according to claim 1, wherein the liquid discharge passage is a through hole leading from the receiving part to an end face on the front side of the main body frame.

3. The card reader according to claim 2, wherein
the main body frame comprises:
a first frame which is formed with the moving passage forming face; and
a receiving part forming member which is formed with a first receiving part structuring a portion on the first direction side of the receiving part and is fixed to the first direction side of the first frame,
in a case that an opposite side to the first direction side is referred to as a second direction side, the first frame is formed with an opening part structuring a portion on the second direction side of the receiving part,
a sealing member for preventing leakage of liquid from a portion between the first frame and the receiving part forming member is disposed between the first frame and the receiving part forming member,
the receiving part forming member comprises a first front wall part structuring a front side face of the receiving part forming member,
the first frame comprises a second front wall part disposed on the front side with respect to the first front wall part, and
the liquid discharge passage is structured of a first liquid discharge passage which penetrates through the first front wall part, and a second liquid discharge passage penetrating through the second front wall part.

4. The card reader according to claim 3, wherein a first liquid discharge passage end which is an end on the first direction side of the first liquid discharge passage is disposed on a lower side in the vertical direction with respect to a face on the first direction side of the receiving part which is formed in a flat face shape.

5. The card reader according to claim 4, wherein
the receiving part forming member is formed with a recessed part which is disposed on the rear side with respect to the first liquid discharge passage and is connected with the first liquid discharge passage and is recessed from a face on the first direction side of the receiving part toward the first direction side, and
an end on the first direction side of the recessed part is disposed at a same position as the first liquid discharge passage end in the thickness direction of the card.

6. The card reader according to claim 2, further comprising a front face cover which is formed with the card insertion slot and is attached to a front side portion of the main body frame,
wherein the front face cover is provided with a front side arrangement part which is disposed on the front side with respect to the liquid discharge passage, and
the front side arrangement part is formed with a cover side liquid discharge passage which is a through hole for discharging liquid.

7. The card reader according to claim 6, wherein the cover side liquid discharge passage is disposed on a lower side in the vertical direction with respect to the liquid discharge passage.

8. The card reader according to claim 6, wherein
the front face cover is formed with a finger insertion part into which fingers of a user are inserted at a time of insertion of the card to the card reader and pulling-out of the card from the card reader,
the finger insertion part is recessed from a face on the front side of the front face cover toward the rear side,
a face on the first direction side of the finger insertion part is formed in an inclined face which is inclined toward the first direction side as going to the front side,
a portion on the rear side and the first direction side of the finger insertion part is the front side arrangement part, and
a face on the first direction side of the cover side liquid discharge passage is connected with the inclined face.

9. The card reader according to claim 1, further comprising at least a data reading mechanism for reading data recorded in the card,
wherein at least a part of the receiving part is disposed on the front side with respect to the data reading mechanism.

10. The card reader according to claim 9, wherein
the data reading mechanism is an IC contact block having a plurality of IC contact springs structured to be in contact with an external connection terminal of an IC chip formed in the card,
in a case that an opposite side to the first direction side is referred to as a second direction side, the IC contact block is disposed on the second direction side with respect to the moving passage forming face,
the main body frame comprises a first frame in which the moving passage forming face is formed, and a receiving part forming member which is formed with a first receiving part structuring a portion on the first direction side of the receiving part and is fixed to the first frame on the first direction side,
the first frame is formed with an opening part structuring a portion on the second direction side of the receiving part,
the first frame comprises a facing part which faces the IC contact block from the first direction side, and
a part of the first receiving part is disposed on the first direction side with respect to the facing part.

11. The card reader according to claim 1, wherein
the main body frame comprises a first frame in which the moving passage forming face is formed, and a receiving part forming member which is formed with a first receiving part structuring a portion on the first direction side of the receiving part and is fixed to the first frame on the first direction side,
in a case that an opposite side to the first direction side is referred to as a second direction side, the first frame is formed with an opening part structuring a portion on the second direction side of the receiving part,
at least a part of a portion where the opening part is not formed in the first frame is formed to be a moving passage forming part where the moving passage forming face is formed, and
a part of the first receiving part is disposed on the first direction side with respect to the moving passage forming part.

12. The card reader according to claim 1, further comprising a printed board which is disposed on the front side with respect to the receiving part,
wherein the printed board is formed with a detection circuit for detecting at least one of its own disconnection and its own short circuit.

13. The card reader according to claim 12, further comprising a front face cover which is formed with the card insertion slot and is attached to a front side portion of the main body frame,
wherein the printed board is a flexible printed board and is disposed between the main body frame and the front face cover in the moving direction of the card.

14. The card reader according to claim 13, wherein
the liquid discharge passage is a through hole leading from the receiving part to an end face on the front side of the main body frame, and
a portion of the printed board overlapping with the liquid discharge passage in the moving direction of the card is formed with a liquid discharge hole penetrating through the printed board in the moving direction of the card.

15. The card reader according to claim 14, wherein
the front face cover comprises a front side arrangement part which is disposed on the front side with respect to the liquid discharge passage,
the front side arrangement part is formed with a cover side liquid discharge passage which is a through hole for discharging liquid, and
a portion of the printed board overlapping with the cover side liquid discharge passage in the moving direction of the card is formed with a cut-out part.

16. The card reader according to claim 12, further comprising:
a magnetic head for performing at least one of reading of magnetic data recorded in the card and recording of magnetic data to the card; and
a second printed board connected with the magnetic head,
wherein the magnetic head is disposed on the front side with respect to the receiving part,
the second printed board is formed with a detection circuit for detecting at least one of its own disconnection and its own short circuit, and
the printed board and the second printed board are structured to be an integrally formed flexible printed board.
